(19) United States
(12) Patent Application Publication
(10) Pub. No.: US 2025/0371624 A1
(43) Pub. Date: Dec. 4, 2025

(54) COMPUTER-IMPLEMENTED SYSTEM THAT ENABLES A LIVE VIRTUAL INSPECTION TO TRANSFORM INTO A SELF-GUIDED INSPECTION

(71) Applicant: VuSpex Virtual Inspections, Inc., Watsonville, CA (US)

(72) Inventors: Kevin KALAJAN, Arroyo Grande, CA (US); Zakaria TAYEB BEY, Algiers (DZ)

(21) Appl. No.: 18/676,026

(22) Filed: May 28, 2024

(51) Int. Cl. G06Q 30/015

(52) U.S. Cl. CPC G06Q 30/015

(57) ABSTRACT

A computer-implemented system that enables a live virtual inspection to transform into a self-guided inspection includes: an inspector platform and at least one field agent platform, the system configured to: establish a data connection between the inspector platform and the at least one field agent platform; receive a download of a guidesheet document at the at least one field agent platform, the guidesheet including information indicative of an inspection type and identification of required artifacts for the inspection type; enable upload of artifacts from the at least one field agent platform to the inspector platform via the data network; detect a loss of the data connection; enable the at least one field agent platform to continue collection of artifacts for local storage during the loss of the data connection; and enable the at least one field agent platform to upload artifacts from local storage after the data connection is restored.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and disclosure as described below and to the drawings that form a part of this document: Copyright 2024, Kevin Kalajan, Zakaria Tayeb Bey and VuSpex Virtual Inspections, Inc. All Rights Reserved.

### TECHNICAL FIELD

This patent application relates to the field of virtual inspection software, mobile devices, network media and data communications, and mobile communications in the various example embodiments disclosed herein.

### BACKGROUND

Over the past ten years, the Internet (public networking) has been used to upload multimedia content from a mobile device to various web services. For example, an insurance company may allow an insured to upload photos or other content related to damage to their vehicle as proof, instead of an adjuster personally visiting the vehicle.

Furthermore, in the past five years, inspection departments from Community Development public agencies and private sector companies are increasingly allowing live virtual inspections vs. in-person inspections for a variety of domain-specific content and use cases.

U.S. Pat. No. 10,796,374 references the use of aerial images to conduct a virtual inspection based on an inspection model within a time threshold.

U.S. Pat. No. 11,963,072 references a way to initiate a mechanism to upload images via MMS in cases of poor connectivity.

US Patent Application Publication US20230269105A1 references a way to authenticate an image taken on a device to ensure it is not forged; but, in no way handles a live virtual inspection transitioning to a self-guided inspection with no network connection (in fact, it requires a network connection for blockchain maintenance).

These patents and other related conventional technologies do not provide a system or method for automatically transitioning to a self-guided inspection from a live (guided) virtual inspection. The disclosed example embodiments provide the ability to transition from a live virtual inspection to a self-guided inspection upon network failure or other factors and does not leverage MMS to upload artifacts. Thus, a computer-implemented system and method that enables a live virtual inspection to transform into a self-guided inspection is needed.

### BRIEF DESCRIPTION OF THE DRAWINGS

Embodiments are illustrated by way of example and not limitation in the figures of the accompanying drawings, in which:

FIG. 1 depicts the core elements of an example embodiment and their logical connection points;

FIG. 2 illustrates the basic User Interface (UI) components for the Field Agent (FA) to both view the guidesheet of required artifacts and a way to add artifacts prior to upload;

FIG. 3 illustrates the components of the notification system of an example embodiment;

FIG. 4 illustrates an example embodiment of the logical flow of session creation and detection of connection termination;

FIG. 5 illustrates an example embodiment of the transition to a self-guided mode with no network and media gathering while there is no network connection;

FIGS. 6 and 7 illustrate an example embodiment of the upload when network connectivity has been regained, including notification to relevant personnel of the upload and connectivity event; and

FIG. 8 is a processing flow diagram that illustrates an example embodiment of a method as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a computer-implemented system and method for automatically transitioning to a self-guided inspection from a live virtual inspection are disclosed. In the disclosed example embodiments, a system and method manages the detection that a live virtual inspection has terminated, and, upon various factors, transitions the remote user to a self-guided inspection in a way that informs the remote user what artifacts (e.g., documents, images, videos, etc.) are required to complete the self-guided inspection, assigns the uploaded media to specific inspection records, and provides the ability to support images and video along with obtaining GPS coordinates of said media and reverse geocoding to street address the location of the media along with a watermark that shows the date and time the media was taken along with the reverse geocoded street address. Further, the Inspector who was associated with the remote user during the live inspection component of the inspection is notified that the remote user has initiated an upload of additional inspection artifacts (which servers to inform the Inspector that connectivity has been re-gained by the remote user in case the Inspector wants to re-establish a live inspection) and, as well, thumbnails or provides other descriptions of the content that are subsequently attached to the relevant inspection record. The disclosed example embodiments allow an Inspector (or associated organization) to define the instructions for a self-guided inspection, which takes into account various sub inspection types (e.g. “Water Heater Replacement”, “A/C Mechanical Changeout”, etc.) to prepare the description of artifacts required for each inspection type prior to the inspection being initiated (usually a one-time task, not per-inspection, in one embodiment).

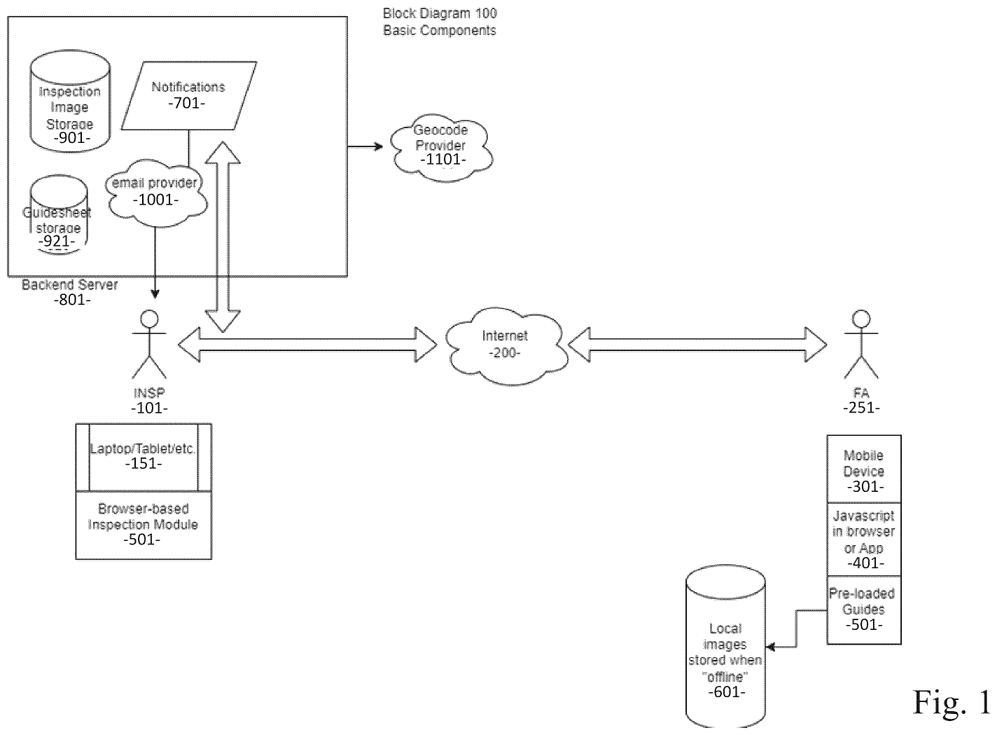

Referring to FIG. 1, the diagram illustrates an example embodiment showing the overall connectivity between an Inspector (“INSP”, element 101) at an INSP platform and a Field Agent (“FA”, element 251) at an FA platform. The INSP is the user, typically in front of a laptop (but could be other devices or platforms), and the FA is the user who is at the remote location to be inspected, typically with a phone, mobile device, or other platform (in one embodiment).

The INSP does not use or require any “App” to be installed and typically just uses a traditional web browser-based experience. The FA may use an App (e.g., software application) as an implementation vehicle for an embodiment, but this is not required and the disclosed example embodiments specifically show the details for implementing the valuable feature without any App installation. Anyone of ordinary skill in the art, in view of the disclosure herein, could implement the embodiments described for the browser-based version via an App (especially since most App frameworks are Javascript™-based).

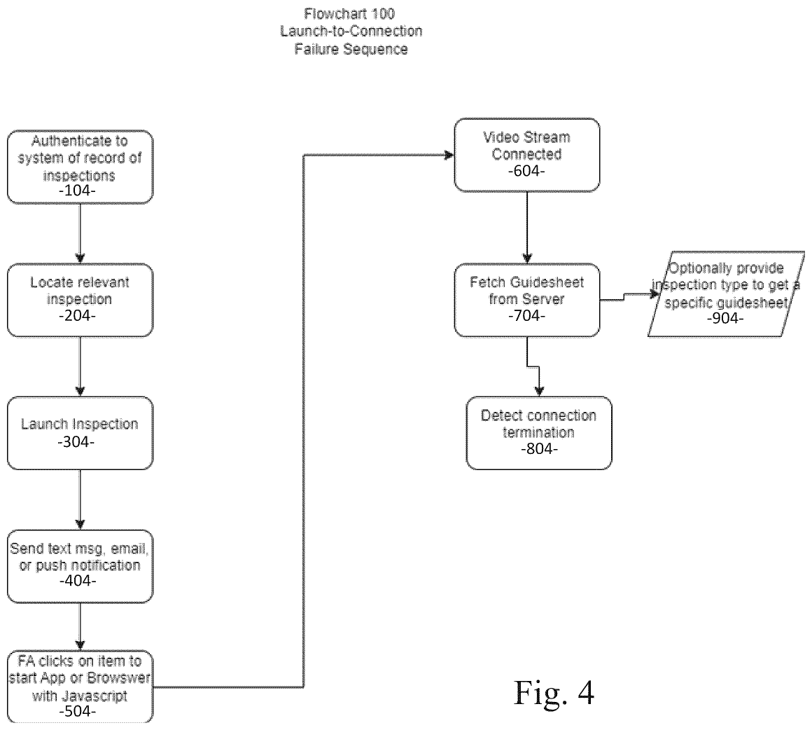

First, the INSP locates the logical inspection that must be performed. See FIG. 4, steps 104-204. This may utilize a tuple containing address, inspection type, phone number of the FA, permit number, job number and any arbitrary list of relevant metadata. This can be stored in a spreadsheet but, in other embodiments, may be stored in a custom application program, Salesforce™, Land Management or Permitting systems, contact management systems, etc. The storage and launch of the inspection is not material to the disclosed embodiments as what is described in the event will work independently and easily with any system-of-record that stores inspections and their metadata.

After locating the desired inspection, a request is initiated to “launch” the inspection (step 304 in FIG. 4). This means the FA is contacted via a push notification (in the case of an App) or text message (in the case of just a browser-based implementation) or any other analogous mechanisms available (see step 404 in FIG. 4). Generally, the FA doesn't have to authenticate (in one embodiment). The FA receives the text message or push notification and then immediately an App is launched or Javascript is loaded into the browser via HTML and the link is presented in a text message (see step 504 in FIG. 4). Note that the Javascript that is loaded (in the non-App scenario) optionally, in one embodiment, can implement a PWA or “Progressive Web App.” A PWA is an “installed” piece of software that is similar to content on a web browser page, but resides locally and can operate with or without a network. A PWA is similar to a traditional mobile App that is “installed” but does not have to originate from the “App Store” or “Play Store” (but can be if required) hence represents an ideal case for implementation if desired. The benefit of the PWA implementation (not required) is that the FA can revisit the PWA at any time by clicking on an icon on the mobile device home screen, whereas a simple web interfaces that is not a PWA would require the user going back to the tab where the software was running—and if the tab has been closed there is no way to continue uploading content if that was required.

In most cases, the FA connects to the INSP via a streaming video connection (e.g. WebRTC but could be any analogous video streaming service.) See step 604 in FIG. 4.

Either the App or Javascript in the browser or PWA optionally requests a guidesheet document to show the FA in case the connection terminates due to a poor connection. While not required, without this, the FA would not know what artifacts they must provide to the INSP to complete the inspection. The guidesheet document can have many sections with internal anchors or be a document specific to the inspection type launched. Either way, the content is stored on the server and delivered to the FA's App or Browser prior to the session terminating. See step 704 in FIG. 4.

In step 904 in FIG. 4, it should be noted that when the request is made to load or request the guidesheet for the inspection in case the connectivity fails, the inspection type or ID can be sent to the back-end service that returns the guidesheet, such that a specific guidesheet could be fetched just for a single inspection type. This is not required but is just an option in one embodiment. A generic guidesheet can be provided which has multiple sections for all possible types. As well, the guidesheet could have multiple sections for different languages, or the FA's default language could be sent (can be automatically queried via Javascript) in the request to fetch the guidesheet such that a guidesheet in the desired language is returned (if available), instead of different sections in the guidesheet for each possible language (another embodiment). The guidesheet may be HTML, a text file, XML, or a JSON-encoded document or any other format that can be parsed or displayed within the FA device.

The INSP has the option (in one embodiment) to take snapshots or record video artifacts and store/save them as part of the inspection. At some point, the network connection may erode to be insufficient for live video inspection. In fact, the connection may have eroded to zero connection at all. However, this does not mean the logical inspection process must be terminated (but the video stream is typically terminated).

At this point, the underlying Javascript in the browser (or App code, or PWA) detects the network connection has been terminated (see step 804 in FIG. 4). In one embodiment, the reason for termination is not relevant, but in some cases could influence subsequent steps. In some scenarios the root cause of termination may not be known and in other embodiments it may be possible for the network to provide an indication to the App or Javascript/Browser that network bandwidth was the root cause of termination. Some of the following techniques can be used to detect connection termination (with or without the underlying cause): signal from underlying WebRTC (or analog) library that the stream has disconnected, timeout in AJAX (Asynchronous Javascript and XML) or network request, timeout from WebSocket connection, insufficient bandwidth detect from transmission rate indicator, excessive latency, excessive network errors, HTTP status code, number of bytes in a response, response to query to operating system for “number of bars” or signal strength indicator. In the embodiment described, any time the session is terminated, the FA has a screen presented to them to continue the inspection while disconnected from the network. In one embodiment, different messages or screens can be provided based on the reason for the disconnection. For example, if the network existed but was seen as high latency, the FA might see the message “high latency is occurring, please wait a few minutes to see if it clears up.” In another embodiment a high latency detection might immediately force a disconnect and tell the user they need to operate in self-guided mode.

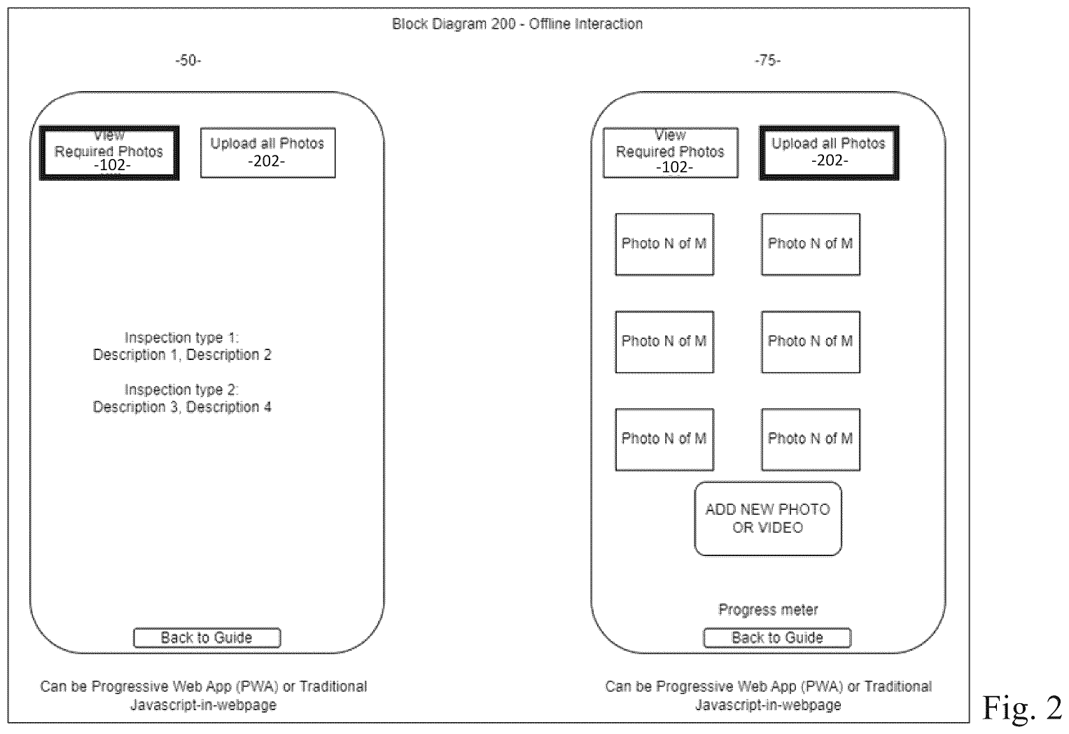

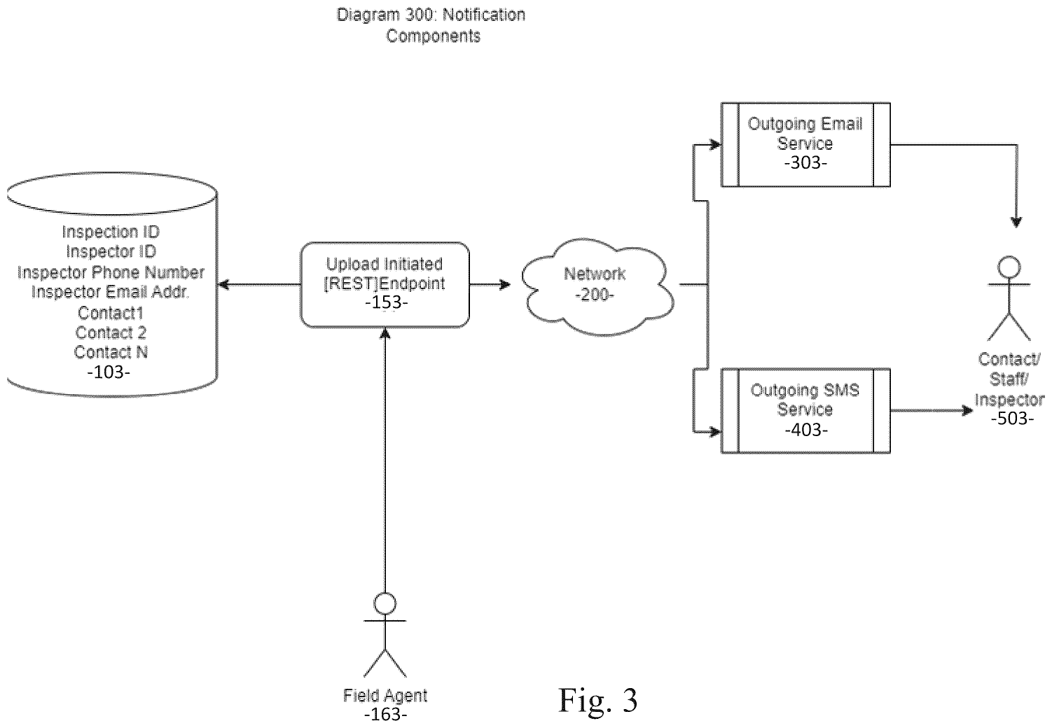

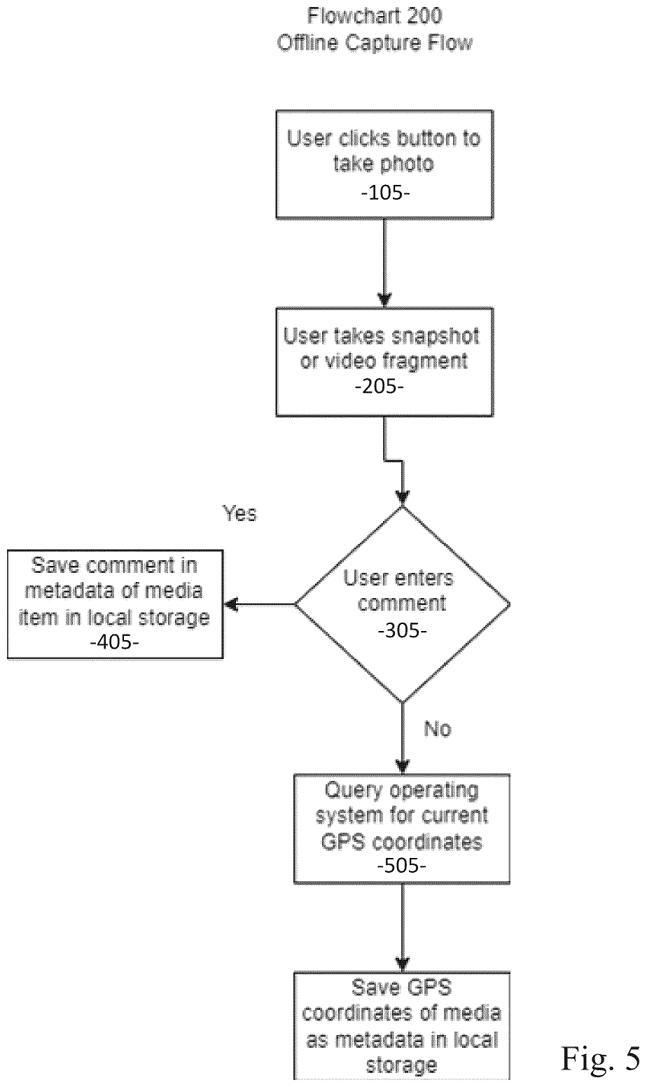

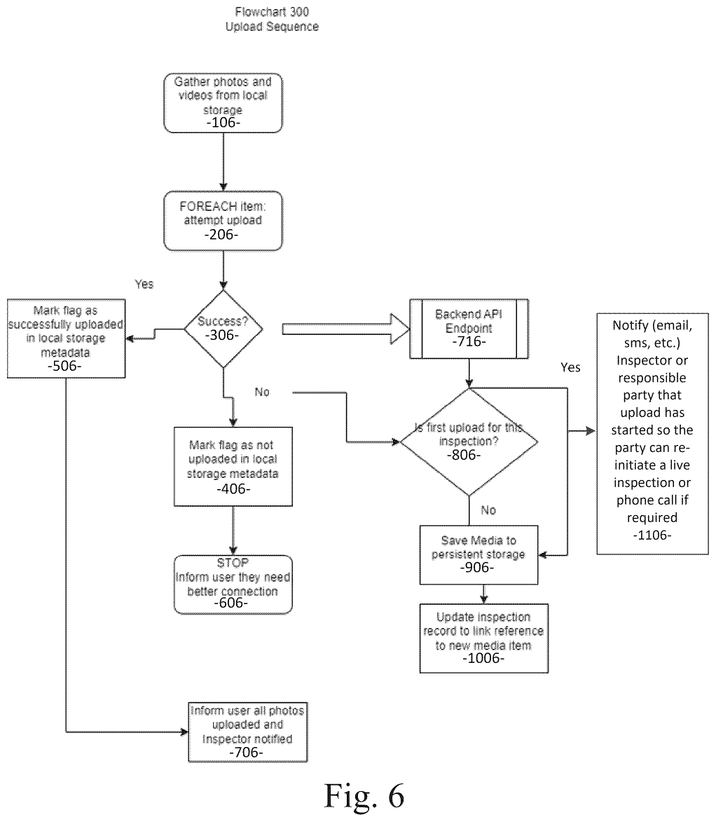

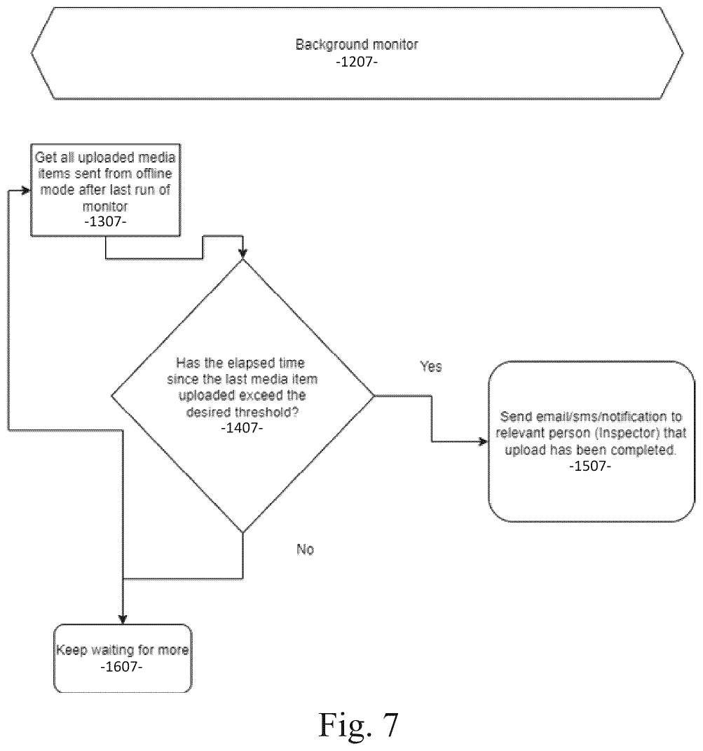

Once the FA agrees to “continue the inspection without a network”, the process flow in an example embodiment can continue as follows.
a. First—when the original connection was made and the Javascript/HTML (or PWA) was loaded into the browser (or App was launched)—a Guidesheet (“GS”) of required photos for each relevant inspection type must be downloaded. This is required in case connectivity is lost and the FA needs to know what artifacts to provide for the inspection type. See step 704 in FIG. 4.
b. The FA is presented a list of inspection types in a menu that allows them to return at any time to review the list (in one embodiment). See FIG. 2, element 50.
c. The FA is presented a page/tab where they can add any number of photos or videos while working without a network connection. See FIG. 2, element 75. Note: in one embodiment, a configuration value might limit the total number of photos, total number videos, max duration of each video, etc. This configuration variable would be provided to the App or PWA or Javascript upon the initial load of the software when the inspection begins. It must be done at that time; otherwise, if the network fails, the configuration could not be retrieved.
d. Each photo or video may, in one embodiment, allow the FA to add a comment to the media item/artifact. See step 305 in FIG. 5.
e. Each photo that is taken has its GPS coordinates (or other geo-location) stored by making a request to navigator.getLocation( ) or equivalent. This is kept in local storage on the FA device so it can be uploaded to the backend when a connection is available. See step 505 in FIG. 5. In the event the FA does not agree to sharing location, one embodiment may reject the use of the feature while another may use a previously cached location value or simple indicate the location is not accessible.
f. The FA is presented a page/button where they can upload all the images once they have completed taking the required photos and they have regained or restored a network connection. See element 202 in FIG. 2. In one embodiment, the FA can optionally click a button to download any or all photos or videos taken to their local device in the event something happens to the uploaded content (e.g. not received).
g. When the FA clicks the button to upload, the back-end processor sends a message (in one embodiment), possibly EMAIL or SMS, to the INSP to indicate the FA is back online (see step 1106 in FIG. 6 and elements 153 and 163 in FIG. 3). This is in case the INSP wants to restart the live inspection now that connectivity exists. Once all the image/video artifacts are uploaded, in one embodiment the INSP is notified that the artifacts have been uploaded to the inspection record and the email may optionally contain FA comments for each artifact as well as thumbnails and links to full videos (see Background Monitor 1207 in FIG. 7, steps 1307, 1407, 1507, and 1607, as well as FIG. 3 elements 103 and 303 through 503).
h. The Background Monitor runs at a configured interval (e.g. 1 minute, 5 minutes, 1 hour, etc.) to algorithmically determine if the FA has completed their media uploads. Note that it simply cannot be assumed that when the FA clicks the UPLOAD button (element 202 in FIG. 2) that all images have been sent. The FA may realize that they forgot some images and may add some more images a few minutes later, or perhaps they go to a different part of a facility and take more photos there so thereby submitting the photos “in batches.” Hence, the Background Monitor determines that the remaining desired media items are now complete by waiting a configurable period of time of no upload, but only once the uploads have started at all (indicating connectivity is established). In another embodiment, a notification can be sent to appropriate staff upon, simply, the initiating of the upload with an assumption that more content may or may not be forthcoming with a separate upload.
i. Whether the App is used by the FA or a Javascript client or PWA-AJAX (or equivalent) requests are made from the FA device “CLIENT” to the backend server resources (BACKEND).
j. The BACKEND can reside on-premises or in a cloud and doesn't impact the disclosed embodiments.
k. The GUIDESHEET content can be stored in an RDBMS, NoSQL Database, S3, Blob Storage, etc. The GUIDESHEET should be fetched when the connection is launched so it is available if/when the connection is terminated. The GUIDESHEET can be HTML, JSON, or another relevant content that can be displayed in a browser (in one embodiment).

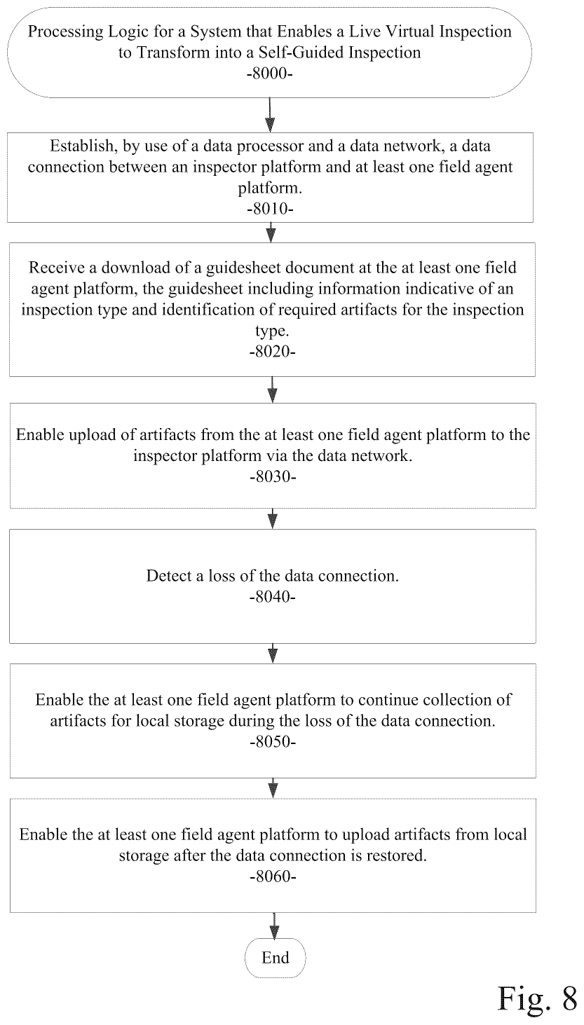

FIG. 8 is a processing flow diagram that illustrates an example embodiment of a method as described herein. Referring now to FIG. 8, a processing flow diagram illustrates an example embodiment of a method implemented by systems as described herein. The method 8000 of an example embodiment includes: establishing, by use of a data processor and a data network, a data connection between an inspector platform and at least one field agent platform (processing block 8010); receiving a download of a guidesheet document at the at least one field agent platform, the guidesheet including information indicative of an inspection type and identification of required artifacts for the inspection type (processing block 8020); enabling upload of artifacts from the at least one field agent platform to the inspector platform via the data network (processing block 8030); detecting a loss of the data connection (processing block 8040); enabling the at least one field agent platform to continue collection of artifacts for local storage during the loss of the data connection (processing block 8050); and enabling the at least one field agent platform to upload artifacts from local storage after the data connection is restored (processing block 8060).

As described herein for various example embodiments, a system and method that enables a live virtual inspection to transform into a self-guided inspection is disclosed. In the various example embodiments described herein, a computer-implemented tool or software application (app) as part of an automated virtual inspection system is described to automate and improve the collection and verification of inspection artifacts between parties in a virtual inspection process. In example embodiments, a network connection may be lost between an inspector and a field agent during the virtual inspection process. The disclosed embodiments enable the live virtual inspection process to transform into a self-guided inspection in the event of a loss of network connectivity. As such, the various embodiments as described herein are necessarily rooted in computer and network technology and serve to improve these technologies when applied in the manner as presently claimed. In particular, the various embodiments described herein improve the use of mobile device technology and data network technology in the context of live virtual inspection via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
establishing, by use of a data processor and a data network, a data connection between an inspector platform and at least one field agent platform;
receiving a download of a guidesheet document at the at least one field agent platform, the guidesheet including information indicative of an inspection type and identification of required artifacts for the inspection type;
enabling upload of artifacts from the at least one field agent platform to the inspector platform via the data network;
detecting a loss of the data connection;
enabling the at least one field agent platform to continue collection of artifacts for local storage during the loss of the data connection; and
enabling the at least one field agent platform to upload artifacts from local storage after the data connection is restored.

2. The method of claim 1 wherein the at least one field agent platform is a mobile device.

3. The method of claim 1 wherein the artifacts are documents, images, or videos.

4. The method of claim 1 wherein the guidesheet document is in a format from a group consisting of: HTML, plain text, XML, a JSON-encoded document, and a format that can be parsed or displayed by the at least one field agent platform.

5. The method of claim 1 including enabling the inspector platform to locate a desired inspection type and notify the at least one field agent platform of the desired inspection type.

6. The method of claim 1 wherein the at least one field agent platform executes processing logic in a form from a group consisting of: a software application (App), software within a browser, and a Progressive Web App (PWA).

7. The method of claim 1 wherein the inspection type is used to fetch a specific guidesheet document corresponding to the inspection type from a backend server.

8. The method of claim 1 including presenting a prompt at the at least one field agent platform advising a field agent to continue an inspection while disconnected from the data network.

9. The method of claim 1 including storing a geo-location corresponding to each of the artifacts.

10. The method of claim 1 including storing comments corresponding to each of the artifacts from a field agent.

11. A system comprising:
an inspector platform; and
at least one field agent platform, the system configured to:
establish, by use of a data processor and a data network, a data connection between the inspector platform and the at least one field agent platform;
receive a download of a guidesheet document at the at least one field agent platform, the guidesheet including information indicative of an inspection type and identification of required artifacts for the inspection type;
enable upload of artifacts from the at least one field agent platform to the inspector platform via the data network;
detect a loss of the data connection;
enable the at least one field agent platform to continue collection of artifacts for local storage during the loss of the data connection; and
enable the at least one field agent platform to upload artifacts from local storage after the data connection is restored.

12. The system of claim 11 wherein the at least one field agent platform is a mobile device.

13. The system of claim 11 wherein the artifacts are documents, images, or videos.

14. The system of claim 11 wherein the guidesheet document is in a format from a group consisting of: HTML, plain text, XML, a JSON-encoded document, and a format that can be parsed or displayed by the at least one field agent platform.

15. The system of claim 11 being further configured to enable the inspector platform to locate a desired inspection type and notify the at least one field agent platform of the desired inspection type.

16. The system of claim 11 wherein the at least one field agent platform executes processing logic in a form from a group consisting of: a software application (App), software within a browser, and a Progressive Web App (PWA).

17. The system of claim 11 wherein the inspection type is used to fetch a specific guidesheet document corresponding to the inspection type from a backend server.

18. The system of claim 11 being further configured to present a prompt at the at least one field agent platform advising a field agent to continue an inspection while disconnected from the data network.

19. The system of claim 11 being further configured to store a geo-location corresponding to each of the artifacts.

20. The system of claim 11 being further configured to store comments corresponding to each of the artifacts from a field agent.
